(19) United States
(12) Patent Application Publication
(10) Pub. No.: US 2025/0066201 A1
(43) Pub. Date: Feb. 27, 2025

(54) RECLAMATION OF METAL FROM COKED CATALYST

(71) Applicant: The Johns Hopkins University, Baltimore, MD (US)

(72) Inventors: Jonah Daedalus Erlebacher, Chevy Chase, MD (US); Gina Reba Greenidge, Baltimore, MD (US); Shashank Vummidi Lakshman, Baltimore, MD (US); Jonathan Luke Horlyck, Washington, DC (US)

(21) Appl. No.: 18/726,201

(22) PCT Filed: Jan. 6, 2023
(86) PCT No.: PCT/US2023/010290

§ 371 Date: Jul. 2, 2024

Related U.S. Application Data
(60) Provisional application No. 63/297,286, filed on Jan. 7, 2022.

(51) Int. Cl. C01B 32/162; C01B 32/05; C01G 53/09

(52) U.S. Cl. CPC C01B 32/162; C01B 32/05; C01G 53/09; C01P 2004/04

(57) ABSTRACT

Removing metal from metal-carbon material includes contacting the metal-carbon material with hydrogen chloride, thereby yielding a metal chloride in the gas phase and a solid product comprising carbon. The metal-carbon material and the solid product may both contain elemental carbon. A concentration of metal in the solid product is typically less than 1 wt %.

### CROSS-REFERENCE TO RELATED APPLICATION

This application claims the benefit of U.S. Patent Application No. 63/297,286 entitled “RECLAMATION OF METAL FROM COKED CATALYST” and filed on Jan. 7, 2022, which is incorporated by reference herein in its entirety.

### FEDERALLY SPONSORED RESEARCH OR DEVELOPMENT

This invention was made with Government support under contract DE-AR0001019 awarded by the Advanced Research Projects Administration—Energy, part of the U.S. Department of Energy. The U.S. Government has certain rights in the invention.

### TECHNICAL FIELD

The presently disclosed subject matter provides a process to remove metals encapsulated by carbon without chemically modifying the carbon.

### BACKGROUND

Metal particles are widely used as catalysts for a variety of chemical reactions. In hydroprocessing, it is common to expose metal particles comprised in part or in whole of nickel, iron, cobalt or other transition metals to hydrocarbons. One mechanism by which catalysts degrade is that substantially pure elemental carbon deposits upon the metal, completely encapsulating the metal with a protective shell of carbon that is resistant to chemical attack. This process is called coking. To recover the metals after deactivation of the catalyst, various strategies have been employed. One strategy is to dissolve the metal in a liquor, usually a strong acid that can attack the metal to form a soluble metal salt. However, usually a substantial portion of the metal (e.g., greater than 5 at. %) is retained, this fraction being highly protected by a carbon shell. Another strategy involves burning off the carbon, leaving the metal behind for re-use. However, this process generally involves the formation of carbon dioxide, a greenhouse gas. Because of the inadequacies of both strategies, it is important to develop new methods to recover metals that do not produce carbon dioxide as a reaction product.

### SUMMARY

This disclosure generally relates to processes for removing metal from mixtures of metal and carbon, particularly mixtures in which the carbon is found to encapsulate some of the metal, without chemically altering the carbon. These processes typically include exposing the metal and carbon mixture to an atmosphere of hydrogen chloride (HCl) gas at temperatures above the boiling point of the metal chloride.

In an embodiment of this process, a nickel-carbon powder mixture formed by methane pyrolysis is exposed to an atmosphere of flowing HCl at an elevated temperature (e.g., 1000° C.). As HCl flows through the mixture, HCl reacts with the nickel in the powder mixture, including nickel exposed to the atmosphere as well as nickel protected by carbon shells. The reaction product is nickel chloride, which sublimes and is carried by the HCl gas until it reaches a colder area and condenses. Suitable metals for this process include nickel, iron, manganese, cobalt, zinc, and magnesium, as well as combinations of two or more of these metals. Carbon formed by this method can be purified to arbitrarily high degrees; commonly the metals content is found to be less than 10 ppm by weight.

Although the disclosed inventive concepts include those defined in the attached claims, it should be understood that the inventive concepts can also be defined in accordance with the following embodiments.

Embodiment 1 is a method of removing metal from metal-carbon material, the method comprising:
contacting the metal-carbon material with hydrogen chloride, thereby yielding a metal chloride in the gas phase and a solid product comprising carbon.

Embodiment 2 is the method of embodiment 1, wherein the metal-carbon material comprises particles of the metal encapsulated by elemental carbon.

Embodiment 3 is the method of embodiments 1 or 2, wherein the metal-carbon material is coked metal-carbon material.

Embodiment 4 is the method of embodiment 3, wherein the coked metal-carbon material is formed in a hydroprocessing reaction catalyzed by the metal.

Embodiment 5 is the method of embodiment 3, wherein the coked metal-carbon material is formed during synthesis of carbon particles catalyzed by the metal.

Embodiment 6 is the method of embodiment 5, wherein the carbon particles have an average diameter in a range of about 100 nm to about 50 microns.

Embodiment 7 is the method of embodiments 5 or 6, wherein the carbon particles are in the form of a carbon aerosol.

Embodiment 8 is the method of embodiments 5 or 6, wherein the carbon particles comprise carbon nanotubes.

Embodiment 9 is the method of any one of embodiments 1-8, wherein the metal-carbon material comprises hydrocarbonaceous material.

Embodiment 10 is the method of any one of embodiments 1-9, wherein a temperature of the hydrogen chloride and the metal-carbon material after contacting is greater than or equal to a boiling point of the metal chloride.

Embodiment 11 is the method of any one of embodiments 1-10, further comprising condensing the metal chloride by reducing a temperature of the metal chloride to a temperature lower than a boiling point of the metal chloride.

Embodiment 12 is the method of any one of embodiments 1-11, wherein a concentration of metal in the solid product is less than 1000 ppm by weight, less than 100 ppm by weight, or less than 10 ppm by weight.

Embodiment 13 is the method of any one of embodiments 1-12, wherein the metal comprises nickel, iron, manganese, cobalt, zinc, vanadium, molybdenum, magnesium, aluminum, tungsten, or and alloy or compound thereof.

Embodiment 14 is the method of any one of embodiments 1-13, wherein the hydrogen chloride is in the gaseous state.

Embodiment 15 is the method of embodiment 14, wherein contacting the metal-carbon material with the hydrogen chloride comprises flowing the hydrogen chloride over the metal-carbon material or through the metal-carbon material.

Embodiment 16 is the method of any one of embodiments 1-15, wherein a temperature of the hydrogen chloride is at least about 1000° C.

Embodiment 17 is the method of any one of embodiments 1-16, wherein contacting the metal-carbon material with hydrogen chloride occurs in a reactor.

Embodiment 18 is the method of embodiment 17, wherein the reactor comprises a tube reactor.

Embodiment 19 is the method of any one of embodiments 1-18, further comprising heating the metal-carbon material.

Embodiment 20 is the method of embodiment 19, wherein heating the metal-carbon material comprises radiative heating.

Embodiment 21 is the method of embodiment 20, wherein the radiative heating comprises heating with microwave radiation.

Embodiment 22 is the method of embodiment 19, wherein heating the metal-carbon material comprises electric resistive heating.

Embodiment 23 is the method of embodiment 22, wherein the electric resistive heating comprises heating with a heating element.

Embodiment 24 is the method of embodiment 19, wherein heating the metal-carbon material comprises Joule heating.

Embodiment 25 is the method of embodiment 24, wherein the Joule heating comprises running current through the metal-carbon material.

Embodiment 26 is the method of any one of embodiments 1-25, wherein the metal-carbon material is provided on a substrate.

Embodiment 27 is the method of any one of embodiments 1-26, wherein the solid product comprises elemental carbon.

Certain aspects of the presently disclosed subject matter having been stated hereinabove, which are addressed in whole or in part by the presently disclosed subject matter, other aspects will become evident as the description proceeds when taken in connection with the accompanying Example and Figure as best described herein below.

### BRIEF DESCRIPTION OF DRAWINGS

FIG. 1 shows a transmission electron micrograph of carbon-encapsulated nickel particles formed by methane pyrolysis.

FIG. 2 shows a transmission electron micrograph of hollow carbon particles formed after exposing carbon-encapsulated nickel particles to hydrogen chloride at 1000° C.

### DETAILED DESCRIPTION

Provided herein are methods of removing metal from material including metal and carbon (“metal-carbon material”). The methods include: contacting the metal-carbon material with hydrogen chloride, thereby yielding a metal chloride in the gas phase and a solid product comprising carbon. In some embodiments, contacting the metal-carbon material with hydrogen chloride occurs in a reactor (e.g., a tube reactor). In some embodiments, the metal-carbon material is provided on a substrate. The substrate can refer to any underlying material or materials that may be used, or upon which, a metal-carbon material disclosed herein may be contacted with hydrogen chloride.

The metal-carbon material disclosed herein can be particles of the metal encapsulated by elemental carbon. In some embodiments, the metal-carbon material is coked metal-carbon material. For example, the metal-carbon material disclosed herein can be a degraded metal catalyst (e.g., from a hydroprocessing reaction), that is coated (e.g., encapsulated) with carbon (e.g., a coked metal-carbon material, wherein the coke can be a carbonaceous or hydrocarbonaceous deposit on the metal). In some embodiments, the coked metal-carbon material is formed in a hydroprocessing reaction catalyzed by the metal. In some embodiments, the coked metal-carbon material is formed during synthesis of carbon particles catalyzed by the metal. The carbon particles can have an average diameter in a range of about 100 nm to about 50 microns. In some cases, the carbon particles are in the form of carbon nanotubes or carbon aerosols. As used herein, the term “hydroprocessing” refers to a variety of catalytic processes including hydrotreating and hydrocracking for the removal of, for example, sulfur, oxygen, nitrogen, and metals, from hydrocarbon products (e.g., oil).

In some embodiments, the carbon of the metal-carbon material includes a hydrocarbon group, such as an alkyl group. As used herein, the term “alkyl” refers to substituted or unsubstituted saturated hydrocarbon groups, including straight-chain alkyl and branched-chain alkyl groups that can contain from 1 or more (e.g., 1 to 25, 1 to 15, 1 to 10, 1 to 5, or 1 to 3) carbons in the chain.

The method disclosed herein can include heating the metal-carbon material to a temperature that is greater than or equal to a boiling point of the metal chloride. In some examples, heating the metal-carbon material can be achieved by radiative heating (e.g., with microwave radiation), electric resistive heating (e.g., using heating elements), or Joule heating (e.g., running current through the metal-carbon material to heat it).

In some embodiments, the temperature of the hydrogen chloride and the metal-carbon material after contacting is greater than or equal to a boiling point of the metal chloride. In some embodiments, the temperature of the hydrogen chloride and the metal-carbon material after contacting is at least about 300° C., at least 700° C., at least 900° C., at least about 1000° C., or at least about 1200° C. In some embodiments, the temperature of the hydrogen chloride and the metal-carbon material after contacting is about 700° C. to about 2000° C., about 1000° C. to about 1750° C., or about 1000° C. to about 1600° C. For example, when the metal of the metal-carbon material is nickel and the metal chloride includes Ni(II)Cl₂, the temperature of the hydrogen chloride and the metal-carbon material after contacting is greater than or equal to about 975° C. (the boiling point of Ni(II)Cl₂). In some embodiments, the temperature of the hydrogen chloride is at least about 1000° C.

The method disclosed herein can include condensing the metal chloride by reducing a temperature of the metal chloride to a temperature lower than a boiling point of the metal chloride. In some embodiments, the metal chloride can be condensed to a solid or a liquid. In some embodiments, the temperature of the metal chloride is lowered to less than about 700° C., less than about 500° C., less than about 100° C., or less than about 50° C.

The carbon of the solid product can include, consist essentially of, or consist of elemental carbon. The solid product can include less than 3 wt %, less than 2 wt %, less than 1 wt %, less than 0.1 wt %, or less than 0.01 wt % of the metal. In some embodiments, the concentration of metal in the solid product is less than 1000 ppm by weight, less than 100 ppm by weight, or less than 10 ppm by weight.

In some embodiments, the solid product is substantially free of metal. As used herein, the term “substantially free of” an ingredient(s) as provided in the disclosure is intended to mean that the composition or compound(s) contain less than about 0.1 wt % or less than about 0.01 wt % (percent by weight of the total weight of the composition or compound(s)), or insignificant or negligible amounts of said ingredient(s) unless specifically indicated otherwise.

The metal of the methods disclosed herein can include nickel, iron, manganese, cobalt, zinc, vanadium, molybdenum, magnesium, aluminum, tungsten, or an alloy or compound thereof. In some embodiments, the metal includes nickel, iron, manganese, cobalt, zinc, magnesium, or an alloy or compound thereof. In some embodiments, the metal includes nickel. In some embodiments, the metal includes iron. In some embodiments, the metal includes manganese. In some embodiments, the metal includes magnesium. In some embodiments, the metal includes cobalt. In some embodiments, the metal includes zinc.

The hydrogen chloride of the method disclosed herein can be in a gaseous state. In some embodiments, contacting the metal-carbon material with the hydrogen chloride comprises flowing the hydrogen chloride over or through the metal-carbon material.

The presently disclosed subject matter now will be described more fully with reference to the accompanying Figures, in which some, but not all embodiments of the presently disclosed subject matter are shown. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

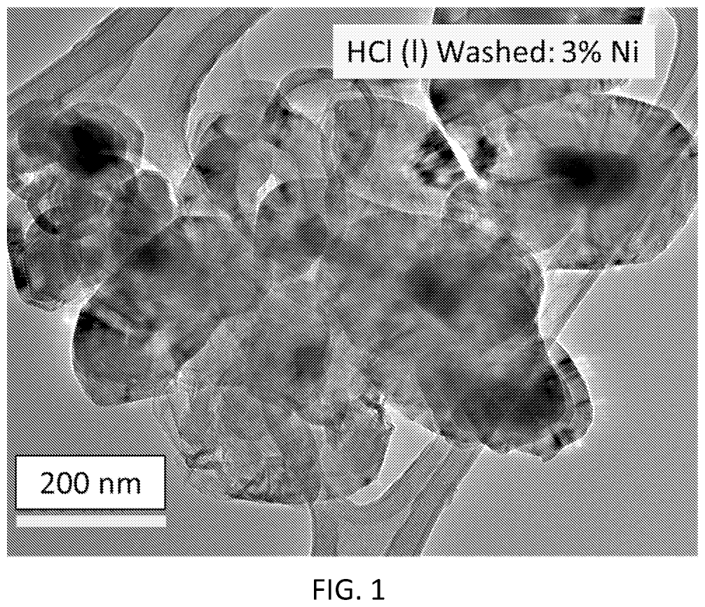

FIG. 1 shows a transmission electron micrograph of carbon encapsulated nickel particles 100. Such particles can be formed by different chemical processes in which a nickel particle pyrolyzes the decomposition of a hydrocarbon into its constituent elements of hydrogen and carbon. In the particular material shown in FIG. 1, the material was formed by methane pyrolysis, i.e., the chemical reaction to produce hydrogen via Reaction (1):

CH₄>C+2H₂ (1)

which is catalyzed by nickel, iron, cobalt, manganese, as well as alloys and chemical compounds comprising these elements. The activity of catalysts for this reaction tend to degrade over time, requiring the catalyst to be recycled. Other forms of metal particles encapsulated include, for example, metal particle catalysts used to synthesize carbon nanotubes. In the synthesis of carbon nanotubes, however, the same problem is encountered as with methane pyrolysis, namely, metal particles eventually become encapsulated with carbon and stop working efficiently as catalysts.

As described herein, flowing hydrogen chloride gas over a mixture of spent metal catalyst leads to separation of the metal from the carbon via the formation of a volatile metal chloride. It is believed that process involves intercalation of hydrogen chloride through the carbon, formation of metal chloride, and the de-intercalation of the metal chloride back out of the particle, followed by sublimation. As such, this process can be used to remove metal that forms a chloride that also is a graphite intercalation compound. Metals in this category include nickel, iron, manganese, cobalt.

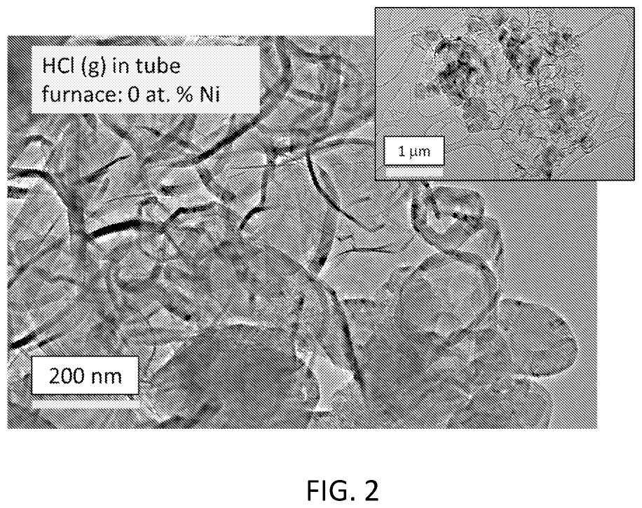

FIG. 2 show a transmission electron micrograph of hollow carbon nanoparticles 200 formed from the material shown in FIG. 1 via the method described herein.

### Example

The following Example is included to provide guidance to one of ordinary skill in the art for practicing implementations of the presently disclosed subject matter. In light of the present disclosure and the general level of skill in the art, those of skill can appreciate that the following Example is intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

Samples of nickel-carbon powder containing ˜10 at. % nickel were placed in a tube furnace and HCl was flowed through it at 1200° C. for periods of time from 30 min to 2 hours. After the time period was complete, the reactor was cooled and purged with argon. Nickel chloride sublimate had condensed on the tube outside of the hot zone. After collecting the carbon, electron dispersive spectroscopy shows the carbon powder had no detectable metal content. Elemental analysis shows the content of Ni to be less than 100 ppm by weight.

Although this disclosure contains a specific embodiment detail, this should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter has been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of removing metal from metal-carbon material, the method comprising:
contacting the metal-carbon material with hydrogen chloride, thereby yielding a metal chloride in the gas phase and a solid product comprising carbon.

2. The method of claim 1, wherein the metal-carbon material comprises particles of the metal encapsulated by elemental carbon.

3. The method of claim 1, wherein the metal-carbon material is coked metal-carbon material.

4. The method of claim 3, wherein the coked metal-carbon material is formed in a hydroprocessing reaction catalyzed by the metal.

5. The method of claim 3, wherein the coked metal-carbon material is formed during synthesis of carbon particles catalyzed by the metal.

6. The method of claim 5, wherein the carbon particles have an average diameter in a range of about 100 nm to about 50 microns.

7. The method of claim 5, wherein the carbon particles are in the form of a carbon aerosol.

8. The method of claim 5, wherein the carbon particles comprise carbon nanotubes.

9. The method of claim 1, wherein the metal-carbon material comprises hydrocarbonaceous material.

10. The method of claim 1, wherein a temperature of the hydrogen chloride and the metal-carbon material after contacting is greater than or equal to a boiling point of the metal chloride.

11. The method of claim 1, further comprising condensing the metal chloride by reducing a temperature of the metal chloride to a temperature lower than a boiling point of the metal chloride.

12. The method of claim 1, wherein a concentration of metal in the solid product is less than 1000 ppm by weight, less than 100 ppm by weight, or less than 10 ppm by weight.

13. The method of claim 1, wherein the metal comprises nickel, iron, manganese, cobalt, zinc, vanadium, molybdenum, magnesium, aluminum, tungsten, or and alloy or compound thereof.

14. The method of claim 1, wherein the hydrogen chloride is in the gaseous state.

15. The method of claim 14, wherein contacting the metal-carbon material with the hydrogen chloride comprises flowing the hydrogen chloride over the metal-carbon material or through the metal-carbon material.

16. The method of claim 1, wherein a temperature of the hydrogen chloride is at least about 1000° C.

17. The method of claim 1, wherein contacting the metal-carbon material with hydrogen chloride occurs in a reactor.

18. The method of claim 17, wherein the reactor comprises a tube reactor.

19. The method of claim 1, further comprising heating the metal-carbon material.

20. The method of claim 19, wherein heating the metal-carbon material comprises radiative heating.

21. The method of claim 20, wherein the radiative heating comprises heating with microwave radiation.

22. The method of claim 19, wherein heating the metal-carbon material comprises electric resistive heating.

23. The method of claim 20, wherein the radiative heating comprises heating with a heating element.

24. The method of claim 19, wherein heating the metal-carbon material comprises Joule heating.

25. The method of claim 24, wherein the Joule heating comprises running current through the metal-carbon material.

26. The method of claim 1, the metal-carbon material is provided on a substrate.

27. The method of claim 1, wherein the solid product comprises elemental carbon.
